(19) United States
(12) Patent Application Publication
(10) Pub. No.: US 2014/0367391 A1
(43) Pub. Date: Dec. 18, 2014

(54) HALF CIRCULAR BAKING PAN AND CARRIER

(71) Applicants: Shelby Jean Perry, Pueblo, CO (US); Candice Crystal Montoya, Pueblo, CO (US); Hadley Scott Perry, Pueblo, CO (US)

(72) Inventors: Shelby Jean Perry, Pueblo, CO (US); Candice Crystal Montoya, Pueblo, CO (US); Hadley Scott Perry, Pueblo, CO (US)

(21) Appl. No.: 13/916,478

(22) Filed: Jun. 12, 2013

(51) Int. Cl. A47J 37/01

(52) U.S. Cl. CPC A47J 37/01
USPC 220/573.1

(57) ABSTRACT

A multi-purpose half circular baking pan that is an improvement to conventional pie/cake pans attempting to produce smaller quantities of pie or cakes or the likes. Its half circular shape allows for the filling and crust ratio that is commonly preferred in pies or cakes or other edibles as described within. This single construction pan, of heat durable material consists, of a half circular bottom, one flat side and a half circular shaped side that connects and extends upward from the bottom. The upper edges have a flange that extends outward creating a handling area around the pan with an extended area on the ends of the circular sides connecting to the flat side producing more of a handle. The carrying tray, of said invention, is used to enable the management of two pans at once during baking or transporting.

### BRIEF SUMMARY OF INVENTION

This present invention solves the need to produce standard size wedge shaped pie or cake or other such edibles when smaller quantities are needed.

It is an object of the present invention to provide a half circular pie or cake pan to produce pies or cakes, be it dairy, fruit, cream, meat, bread, calzone, cheese cake, pizza or other half circular shaped edible items. These multi-purpose half circular pans affords the user to bake and serve these edible food items

The half pie may contain any combination of distinct pie filling materials such as fruits, custards, puddings, vegetables, meats, and the like.

It is another object of the present invention to provide the user a way to produce a natural product without the waste when smaller quantities are needed while still producing the desired wedge shaped servings from the multi-purpose half circular pie pan.

It is further an objective to provide the user a way to bake natural, edible food items more economically, financially and environmentally responsibly, limiting the waste often occurring with conventional sized pie and cake pans. Therefore preserving our natural resources such as grains, fruits, dairy, meats and all other baking ingredients.

It is further an object of the present invention to provide the user the ability to produce the pie with the balanced crust and filling proportion or ratio that a conventional circular pie produces, unlike the crust and filling ratio a mini pie pan produces.

It is further an object of the present invention to provide a simple multi-purpose half circular pie or cake baking pan.

It is further an object of the present invention to provide an easy to store, use and clean multi-purpose baking pan.

It is yet another object of this invention to provide a tray/carrier for the multi-purpose half circular baking pan having means for manually gripping for moving the multi-purpose half circular baking pan before and after the baking process from the preparation surface or the oven after 1 or 2 pans are inserted into the same shaped cutouts in the surface of the tray/carrier.

Still another object of this invention is to provide a half circular pie product by a process including the steps of providing a conventional circular pie pan, depositing a layer of pie dough on the circular bottom and sloping sides of the pie pan, filling the cavity of the pan with pie filling material and cooking the normal baking time until done.

In the preferred embodiment of the present invention, a half circular pan, often referred to as a deep-dish pie pan, has its bottom, sides, and preferably a portion about its rim covered with the bottom layer of pie dough and the cavity of the pan filled with the desired filling at the appropriate time.

The present invention comprising the steps of providing a half circular pan having a half circular bottom, outwardly tapered sides, a straight upward side and a rim; adding a layer of pie dough to cover the half circular bottom, outwardly tapered sides, and a portion of the rim, if desired, an upper crust is placed over the filling and pressed down over the top if desired.

Still another object of the present invention is to provide a half circular cake or bread product, by the process including the steps of processing a conventional circular cake or bread or like food item. This includes the preparing of the pan with and addition non-stick processes need such as oiling and flouring of the pan prior to the filling of the pan with the desired batter or dough.

It is still a further object of this invention to provide a multi-purpose half circular pie or cake baking pan which can be sold or given away with the sale of pie-baking materials such as flour, pie filling mix, pizza making, calzones, cheese cake or the like, and sold to users for public or home baking purposes.

It is yet another object of the present invention to package the multi-purpose half circular pie pan of the present invention, and a lower layer of pie dough disposed in the half pie pan so that the home user can add the necessary pie filling, cover the pie with a top layer of pie dough, if desired and bake the pie until the filling sets.

It is also an object of the present invention to make a preformed frozen half circular pie product comprising the steps of placing a lower layer of pie dough in the bottom of a half circular pie pan, filling the cavity with a distinct pie filling material, baking the pie until the filling material is set before the product is frozen, packaged and sold.

It is still another object of the present invention to provide an improved method for making a frozen pie and the product produced without the waste often experienced with a full size conventional circular pie or cake or such edible food items.

It is still another object to provide a half circular pie or half circular cake pan combination which can be packaged and sold for home bakers.

It is still another object that the tray/carrier may or may-not be packaged with any combination of multi-purpose half circular baking pans.

The multi-purpose half circular pie or cake pan is manufactured from any bake ware material such as stainless steel, but not limited to, aluminum or the like, a heat resistant plastic type material or even a material such as heat-resistant glass, such as sold under the trademark Pyrex, a ceramic material, or the like can be used, but not limited to the mentioned materials.

In one embodiment, the handles are located at the distal ends on the top edge of the pan and extend a predetermined distance above the top edge of the pan for gripping and lifting purposes.

These objects are advantages of the present invention and are apparent to those of ordinary skills in the art of baking upon review of the following Detailed Description, Drawings of the Present Invention, Claims, described herein:

### BACKGROUND OF THE INVENTION

A circular metallic pie pan or cake pan is two of the standard kitchen supplies used in baking. These pans are usually of solid, one piece constructed form and allow for the baking or the conventionally round pie with angular side or cakes in the conventional round shape. It is also common for a baker to have mini pans.

The purpose of multiple size pans is to produce smaller or larger quantities of baked food items. For years many full-sized pies or cakes, be they fruit, meat, vegetables, bread, dairy, or cream or any other such made products have been wasted due to the over production due to the size of the bake ware used. Baking from natural ingredients does not add preservatives that prolong the shelf life of these products; therefore a lesser quantity of product is desirable at times. The production of mini pies is not a desirable solution to this problem of waste. A mini pie contains the same pie dough or crust but has a smaller cavity for the filling therefore reducing the quantity of filling. This filling and crust or dough ratio is not desirable because the primary focus of a pie is the filling. It produces too much crust and not enough filling.

Other inventions have tried to resolve this issue, with complicated apparatus to insert into the pie before, during the construction of the pie. These apparatuses contain screws, moving parts, blades and multiple parts and would not always fit in all conventional pie pans. These apparatuses would require assembly and dismantling to use. They would also require special storage consideration and are complicated to clean.

In light of the complex, costly and inconvenient nature of the previous inventions they do not solve the problem associated with producing a standard wedge shaped piece of pie with the desirable filling and crust ratio. The same is true with production of a smaller cake pan to produce the standard size wedge shapes slice of cake.

Therefore there is still a need for a simple, inexpensive multi-purpose pie or cake pan which would allow for the production of a lesser quantity of edible food items. Such a baking pan would allow the user to bake without waste of resources, such as grains, meat, vegetables, dairy and many other natural ingredients but not limited to those listed.

The end result of this invention allows the user to become more financially, environmentally and economically responsible, therefore this invention is a very marketable and usable bake ware invention.

### PRIOR ART

The public's infatuation with desserts and dessert products has constantly grown over the years, and will, by all reports, continue to do so in the future. Furthermore, the modern trend is exemplified by the fast food market which is constantly looking for new and easy-to-prepare products. Large families are a rarity today, and family-type units of one, two or three members are predominant. Tastes within such families varies also therefore it is often not prudent to bake or buy a whole pie having one single type of filling because it may not meet the taste demands of all of the various members of the family and part, perhaps most, of the pie will go to waste.

In order to meet the taste demands in the family unit methods for making and baking fresh or frozen pies which are fully cooked, partially cooked and/or not baked at all before freezing are well-known. These pies are all found in the frozen food sections of the grocery store, and the like, for home consumption, either after baking is completed or after some degree of heating.

Also because of current trends, there has been a great increase in demand for the sale of relatively small, snack-size pies which are generally lacking in taste, stale before eaten and relatively expensive per portion.

The prior art also teaches a wide range of devices which are similar to or referred to as “dividers”, but which are used only to facilitate the removal of a pie from the pan once it is baked or its removal in sections each having the same identical pie filling. Examples of such devices are shown in U.S. Pat. No. 2,954,729 which issued on Oct. 4, 1960 to C. G. Suica for a Pie Shell Forming Device; U.S. Pat. No. 2,123,359 which issued on Jul. 12, 1938 to E. O. Hallmark for a “Pie Pan”; and U.S. Pat. No. 2,327,988 which issued on Aug. 31, 1943 to Ethel Nell Bassett for a “Pie Pan”. The first of these patents provides a bracket which lies on the bottom of the pie pan and whose only function is to operate to position a device for forming a fluted rim on the pie. The Hallmark Patent teaches a removable divider which is triangular in shape and filled with perforations to provide a pre-divided pie or a pie divided into slices for the purposes of providing separate and distinct filling materials in the various sections; cannot be removed until the pie is 100% baked; is hollow and filled with holes for the purpose of passing heat from one piece to another; and is difficult and messy to clean and maintain. The device actually appears to render it even more difficult to remove a slice of pie from the pie pan or container in which it is baked, and to remove the divider first would destroy the aesthetic appearance of the pie as it ripped through the top shell by the rather wide triangular base portion.

In some patents of the prior art suggest, such as U.S. Pat. D593,363 issued Jun. 2, 2009 to Madeleine A. Collinson a type of divider or separator which is adapted to be removed from the pie before it is completely baked or after it is baked and before it is sliced, and to try to do so would destroy or greatly mess up the pie as a unit and destroy its aesthetic appearance. Furthermore, some of these apparatus, such as U.S. Pat. No. 6,505,809B1 issued to Cathy J. Reed on Jan. 14, 2003 are designed to make a sectional pie capable of having different and distinct pie filling materials in the separate sections, portions or divisions thereof. Lastly, most are extremely complex and mechanically complicated and utilize a plurality or multitude of mechanical pieces and assemblies or modifications to the conventional circular pie pan itself, and are more difficult to clean and more difficult to maintain, such as U.S. Pat. No. ______; also the U.S. Pat. No. 5,074,777 issued on Dec. 24, 1991 to Dennis B. Garner.

Typical of the prior art of baking pre-frozen pies, and representative thereof is U.S. Pat. No. 4,265,919, which issued on May 5, 1981 to Arnold M. Munter and David W. Ahlgren for a Process to produce a frozen, pre-prepared food product such as a pot pie, fruit pie, or the like.

None of the methods for baking or producing pre-frozen pies or cake food items teach or even remotely consider producing a half circular pie or cake, or the likes of, before baking so that we still have the situation where an entire pie or cake, or the likes of food item, must be consumed, regardless of the taste preferences of the buyer and members of the family unit. The present invention would enable the user to prepare and freeze a like food item with the desirable crust and filling ratio using the multi-purpose half circular pan, be it the pie or the cake.

None of the prior art suggest or considers the production of a smaller quantity of product simply by the invention of the present invention of the multi-purpose half circular pie or cake pan.

The present invention provides a method or apparatus not found anywhere in the known prior art, but which solves many of the problems thereof, while avoiding the many problems associated therewith.

### BRIEF DESCRIPTION

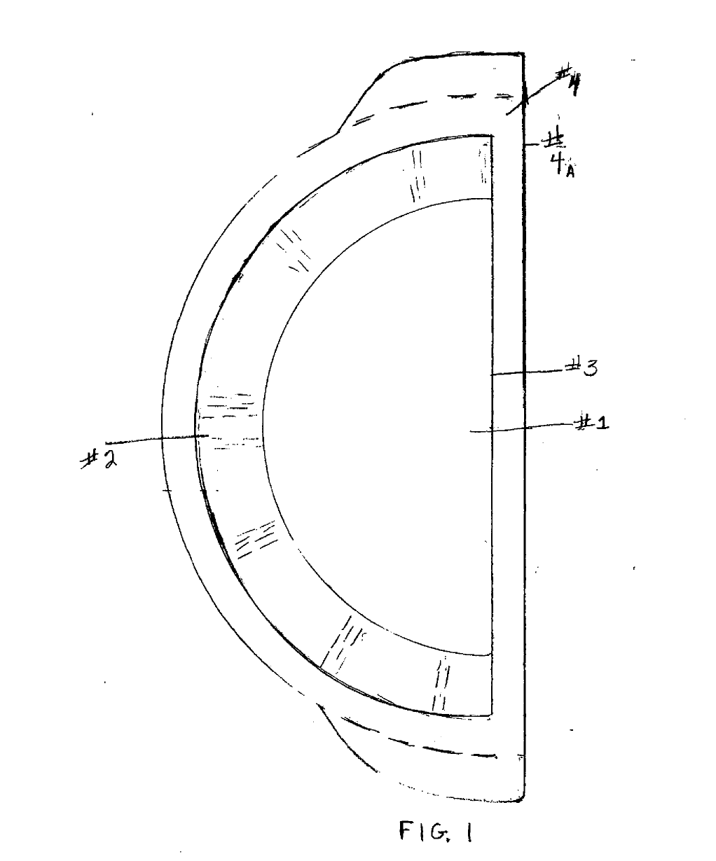

FIG. 1 is a top plan view of present pie or multi-purpose pan.

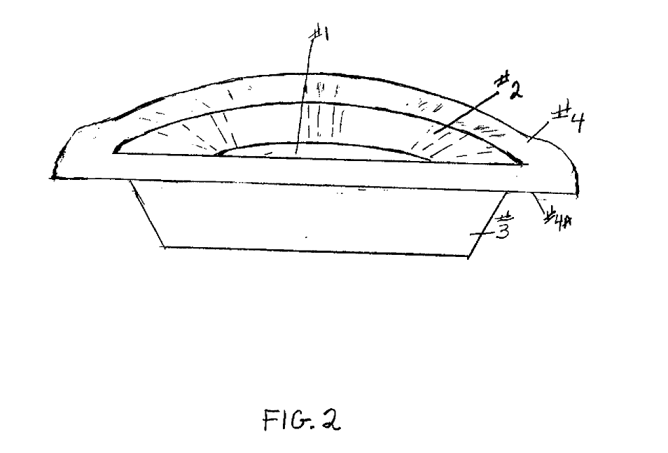

FIG. 2 is a side perspective view of present pie or multi-purpose pan.

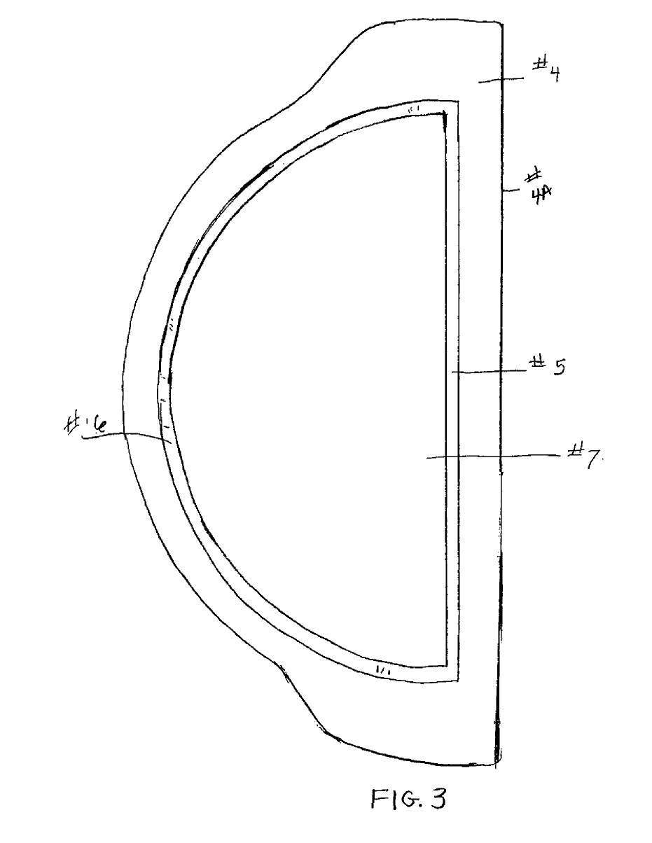

FIG. 3 is a top view of present cake or multi-purpose pan.

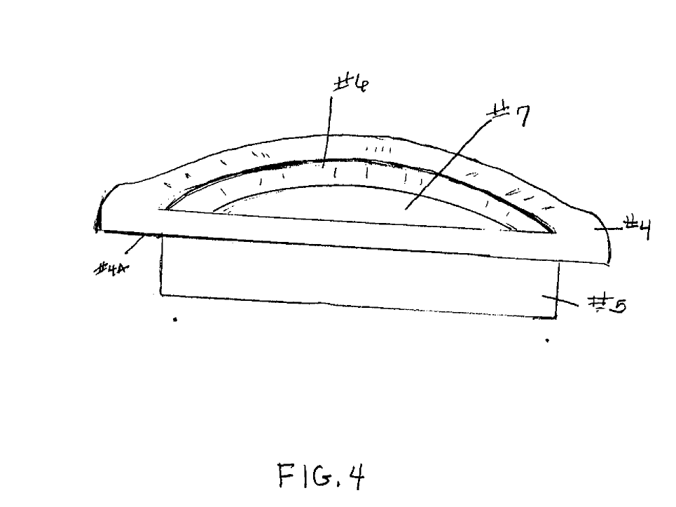

FIG. 4 is a side perspective view of present cake or multi-purpose pan.

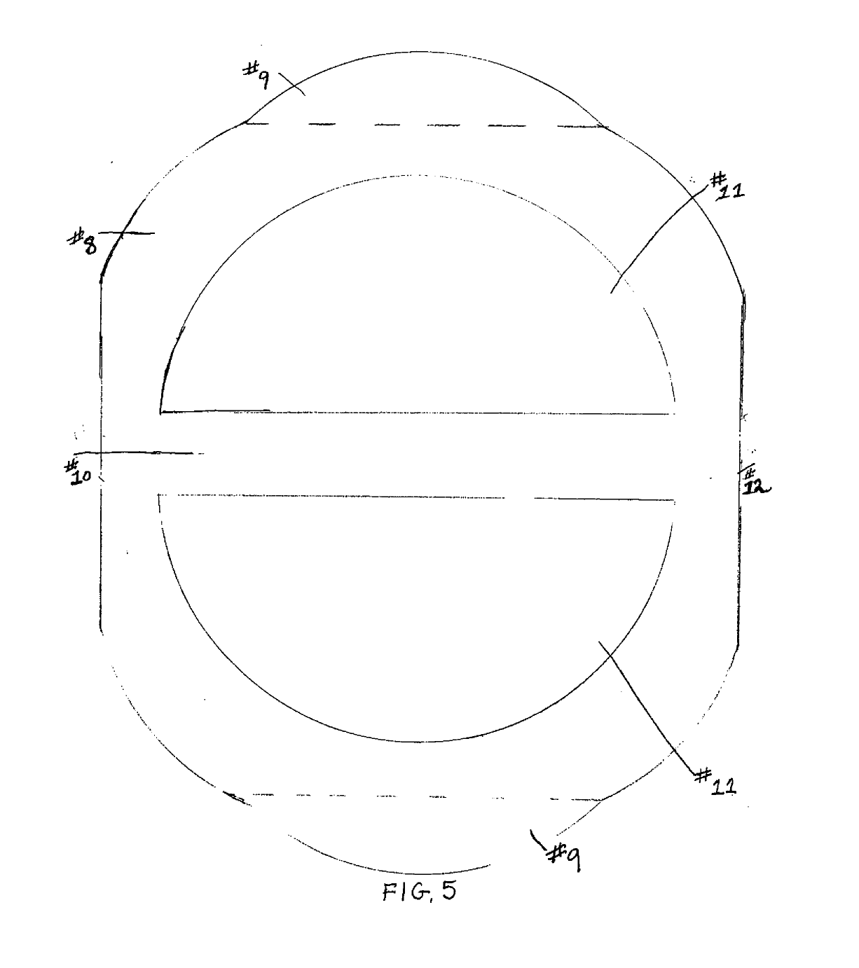

FIG. 5 is a top view of present multi-purpose pan carrier.

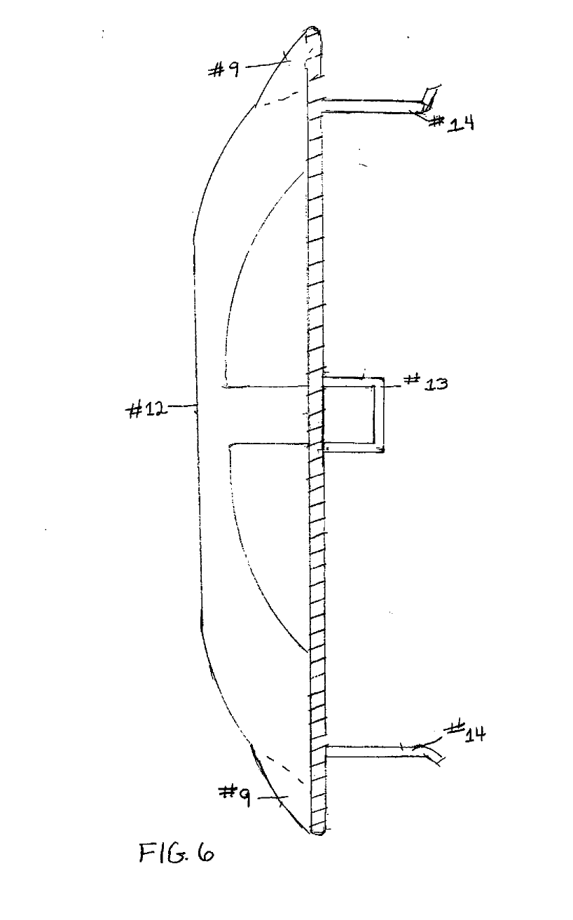

FIG. 6 is a cross section view of present multi-purpose pan tray or carrier.

### DETAILED DESCRIPTION

The invention is capable of other embodiments and of being carried out in various ways. Also it is to be understood that the phraseology and terminology used therein are for the purpose of description and should not be regarded as limiting. It is also to be understood this invention will be made of a stainless steel type baking material, glass, but not limited to any other material used to produce bake ware. The embodiment may also be coated with a non-stick material of any nature. It will be durable and suitable for use at a high temperature, yet also be easy to clean.

FIG. 1 Is a top view of the multi-purpose half circular baking pan used for supporting a food item during preparation and baking. The embodiment of the pan has a flat bottom #1 with angular side walls #2 extending upward and outward on the circular side. There is also a flat sidewall extending straight upward, from bottom #1, as displayed in #3. Attached to all of the upper edges is a flange #4 and #4A that extends outward from the edges of the multi-purpose pie or cake pan. The flange is extended along the half circular edge as well as the straight edge in FIG. 1, FIG. 2, FIG. 3, and FIG. 4. The flange #4 and #4A facilitates gripping, holding and moving the baking pan. In some embodiments the flange #4 and #4a may extend farther to support of a larger dough crust in food items, such as used in the creation of calzones.

FIG. 2 is the side perspective view of multi-purpose half circular pie or cake pan in FIG. 1.

This view represents the flat sidewall #3 of the half circular multi-purpose pie pan. The straight flat sidewall #3 extends straight up from the straight edge of the half circular bottom #1. The flange #4 and #4A extends straight out from all side wall #3 and #2 in FIG. 1 and FIG. 2 to create a lip to support any food item or dough used.

FIG. 3 is a top view of present multi-purpose half-circular cake pan. The view presents the flat half circular bottom #7. The straight flat side wall #5 extends straight up from the half circular flat bottom #7. This view also presents the half circular sidewall #6 that extends straight up from the half circular bottom #7. This views also presents the flange that is attached to the entire upper edge of the side walls #5 and #6. The upper edge of all sidewalls include a flange #4 and #4a extending outward. The flange #4 and #4A facilitates gripping, holding and moving the baking pan. In some embodiments the flange #4 and #4A may extend farther to support of a larger dough crust in food items, such as used in the creation of calzones.

FIG. 4 is a perspective side view of present multi-purpose half circular cake pan in FIG. 3. The view presents the flat sidewall #5 of the half circular multi-purpose cake pan. The straight sidewall #5 extends straight up from the half circular bottom #7, this view also presents the flange #4 and #4A that is attached to the entire upper edge of the side walls #5 and #6. The flange #4 and #4A facilitates gripping, holding and moving the baking pan. In some embodiments the flange #4 and #4A may extend farther to support of a larger dough crust in food items, such as used in the creation of calzones.

FIG. 5 is a top view of the present tray/carrier of the said multi-purpose pie or cake pans. The tray/carrier is an oval shape with two straight side edges #12 and extends half rounded handles on the long edges of the oval #9. Through the center of the oval #8, extending from the flat sides #12, is a flat strip of bake ware material #10 that will allow two of the multi-purpose half circular pans to rest, side by side, when inserted in the two half circular cutouts #11, in the bake ware carrier in FIG. 5 and FIG. 6.

FIG. 6 Is the side cross-section view of the tray/carrier for two half circular multi-purpose pans. In the embodiment, the legs provide a supporting stand for the tray/carrier. It reveals the legs #13 constructed from a rod bent in a continuous u shape to form the support. This form is positioned straight down from the straight edges #12 on the underside of the tray/holder on both #12 sides. The rod is coupled to the tray/carrier by, for example, welding, brazing, or the like. Like legs or support stands are coupled to the underside of the half circular handles, #9, at the ends of the tray/holder. These legs or supports are constructed in the same manner as #13. There are a total of 4 supporting legs or supports but not limited to this.

1. Multi-purpose half circular baking pan, Pie/cake or the like, that enables the user to produce half circular food products in the same desirable portions, crust or dough ratio to filling comprising;
(a) a half circular flat bottom with a sidewall extending up and outward at an angle on the half circular side, on the flat edge a sidewall extends straight upward from the straight edge of the bottom;
(b) Along the top edge of all sidewalls extends a flange extending outward to create an edge with an extended flange at each end of the flat side of the top edges to create more of a handle;
© an alternate flat bottom half circular pan has sidewalls that extend straight upward from the bottom with the flange extending straight outward, to create the same flange handle, along all top edges of the same half circular and flat edges of the pan;
(d) each of said multi-purpose half circular pans has the allowance of plural sizes, both in depths and widths;

2. The invention tray/carrier comprising;
(a) an almost oval shaped, flat surface tray with two side-by-side half circular shaped cut-outs spaced far enough apart to allow two half circular pans to sit side-by-side when placed into the cutout spaces and not touch for carrying or baking purposes thereof;
(b) several supports or legs are attached to the underside of said tray/carrier to support tray and any contents, such as the multi-purpose half circular pans and their contents, during all processes; the relative size and shape of said tray/carrier has the allowance to vary, be it rectangle or square or the like to accommodate the two half circular baking pans in which it holds.
